(19) United States
(12) Patent Application Publication
(10) Pub. No.: US 2026/0196836 A1
(43) Pub. Date: Jul. 9, 2026

(54) SYSTEM AND METHOD FOR CONTROLLING BATTERY CONDITION AWARE ENERGY STORAGE SYSTEMS

(71) Applicant: Fluence Energy, LLC, Arlington, VA (US)

(72) Inventors: Thomas Jeffrey Winter, Decatur, GA (US); Timothy Effio, Arlington, VA (US); Brett Lance Galura, Vienna, VA (US)

(73) Assignee: Fluence Energy, LLC, Arlington, VA (US)

(21) Appl. No.: 18/839,771

(22) PCT Filed: Feb. 27, 2024
(86) PCT No.: PCT/US2024/017385

§ 371 Date: Aug. 20, 2024

Related U.S. Application Data
(60) Provisional application No. 63/448,556, filed on Feb. 27, 2023.

(51) Int. Cl. H02J 3/32; H02J 7/50; H02J 7/65; H02J 7/82; H02J 7/84; H02J 7/90; H02J 103/35

(52) U.S. Cl. CPC H02J 3/32; H02J 7/50; H02J 7/65; H02J 7/82; H02J 7/84; H02J 7/977; H02J 2103/35; H02J 2207/20

(57) ABSTRACT

A system includes a plurality of energy storage nodes and a control system. The energy storage nodes include a battery storage element, a power conversion subsystem, and a control subsystem to receive battery data. The control subsystem or the control system is configured to determine at least one battery condition about one or more of the energy storage nodes from the battery data. The control system is configured to create one or more limits, restrictions, or preferences on operation of the one or more energy storage nodes based on: (1) the at least one battery condition; and (2) a required power flow or an overall operating intent. The control system is configured to dispatch the required power flow or the overall operating intent across the plurality of energy storage nodes based on the one or more limits, restrictions, or preferences on operation.

### CROSS-REFERENCE TO RELATED APPLICATIONS

This application claims priority to U.S. Provisional Patent Application No. 63/448,556, filed on Feb. 27, 2023, titled “System and Method for Controlling Battery Condition Aware Energy Storage Systems,” the entire disclosure of which is incorporated by reference herein.

### TECHNICAL FIELD

The present subject matter relates to energy storage systems that include a plurality of energy storage nodes and creating one or more limits, restrictions, or preferences on operation of the one or more energy storage nodes based on at least one battery condition. The present subject matter also encompasses dispatching a required power flow or an overall operating intent across the plurality of energy storage nodes based on one or more limits, restrictions, or preferences on operation.

### BACKGROUND

An energy storage system, such as a battery energy storage system (BESS), can be set up in a distributed manner to satisfy safety and economical concerns. The energy storage system often includes many energy storage nodes that each include an enclosure that houses many batteries inside. Typically, the energy storage system includes a control system that monitors the energy storage nodes.

Current state of the art control systems for energy storage systems can implement limits on an energy storage node based on state of charge, voltage, and temperature. But the control systems do not use deeper insights into battery conditions to create limits, restrictions, or control preferences on the energy storage nodes. Consequently, existing energy storage systems may have higher upfront and operating costs, last a shorter duration, and may be less safe to operate.

### SUMMARY

In a first example, an energy storage system 101 includes a plurality of energy storage nodes 105A-N. The plurality of energy storage nodes 105A-N include a battery storage element 106, a power conversion subsystem 107, and a control subsystem 110 to receive battery data 111A-N from the battery storage element 106, the power conversion subsystem 107, or a combination thereof. The energy storage system 101 further includes a control system 115 configured to receive or store a required power flow 112 or an overall operating intent 113. The control subsystem 110 or the control system 115 is configured to determine at least one battery condition 116A-O about one or more of the energy storage nodes 105A-N from the battery data 111A-N. The control system 115 is configured to create one or more limits 117A-N, restrictions 118A-N, or preferences 119A-N on operation of the one or more energy storage nodes 105A-N based on: (1) the at least one battery condition 116A-O; and (2) the required power flow 112 or the overall operating intent 113. The control system 115 is configured to dispatch the required power flow 112 or the overall operating intent 113 across the plurality of energy storage nodes 105A-N based on the one or more limits 117A-N, restrictions 118A-N, or preferences 119A-N on operation.

In a second example, a non-transitory computer-readable medium 313, 353 includes battery condition aware control programming 330A-B. Execution of the battery condition aware control programming 330A-B by one or more processors 312, 352 configures one or more computing devices 115, 110 to determine, at least one battery condition 116A-O about one or more energy storage nodes 105A-N from battery data 111A-N. The energy storage nodes 105A-N include a battery storage element 106, a power conversion subsystem 107, and a control subsystem 110 to receive the battery data 111A-N from the battery storage element 106, the power conversion subsystem 107, or a combination thereof. Execution of the battery condition aware control programming 330A-B by the one or more processors 312, 352 configures the one or more computing devices 115, 110 to create one or more limits 117A-N, restrictions 118A-N, or preferences 119A-N on operation of the one or more energy storage nodes 105A-N based on: (1) the at least one battery condition 116A-O; and (2) a required power flow 112 or an overall operating intent 113. Execution of the battery condition aware control programming 330A-B by the one or more processors 312, 352 configures the one or more computing devices 115, 110 to dispatch the required power flow 112 or the overall operating intent 113 across the plurality of energy storage nodes 105A-N based on the one or more limits 117A-N, restrictions 118A-N, or preferences 119A-N on operation.

In a third example, a method 700 includes determining, via a control subsystem 110 or a control system 115, at least one battery condition 116A-O about one or more energy storage nodes 105A-N from battery data 111A-N. The energy storage nodes 105A-N include a battery storage element 106, a power conversion subsystem 107, and a control subsystem 110 to receive the battery data 111A-N from the battery storage element 106, the power conversion subsystem 107, or a combination thereof. The method 700 further includes creating, via the control system 115, one or more limits 117A-N, restrictions 118A-N, or preferences 119A-N on operation of the one or more energy storage nodes 105A-N based on:
(1) the at least one battery condition 116A-O; and (2) a required power flow 112 or an overall operating intent 113. The method 700 further includes dispatching, via the control system 115, the required power flow 112 or the overall operating intent 113 across the plurality of energy storage nodes 105A-N based on the one or more limits 117A-N, restrictions 118A-N, or preferences 119A-N on operation.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1 depicts a system that includes an energy storage system, an energy system, and an electrical application.

FIG. 2 illustrates a first energy storage node of a plurality of energy storage nodes of the energy storage system of FIG. 1 coupled to the electrical application.

FIG. 3 is a high-level functional block diagram of the energy storage system of FIG. 1 that depicts components of the control system and the energy storage nodes to control a required power flow and an overall operating intent based on at least one battery condition.

FIG. 4 is a battery condition aware control protocol for the energy storage system that is implemented by the control system and the plurality of energy storage nodes.

FIG. 5 is a block diagram of the control system depicting various types of battery conditions and the plurality of energy storage nodes to implement the battery condition aware control protocol of FIG. 4.

FIG. 6 is a cutaway view of the first energy storage node of the plurality of energy storage nodes and shows details of a plurality of battery storage elements.

FIG. 7 is a flowchart of a method that can be implemented to control a required power flow and an overall operating intent based on at least one battery condition.

### PARTS LISTING

100 System
101 Energy Storage System
102 Energy System
103 Electrical Application
104 Power Conversion System
105A-N Energy Storage Nodes
106, 106A-N Battery Storage Elements
107 Power Conversion Subsystem
108 Transformer
109 Energy Source
110 Control Subsystem
111A-N Battery Data
112 Required Power Flow
112A-N Local Required Power Flows
113 Overall Operating Intent
115 Control System
116A-O Battery Conditions
117A-N Limits
118A-N Restrictions
119A-N Preferences
120 Physical Space
125 Power Bus
205 Power Inverter
210 Rectifier
215 DC-DC Converter
305, 305A-N Network
311, 351 Network Communication Interface
312, 352 Processor
313, 353 Memory
315A-N Sensors
330, 330A-B Battery Condition Aware Control Programming
370A-N Environmental Sensors
375A-N Battery Sensors
400 Battery Condition Aware Protocol
600 Enclosure
700 Method

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

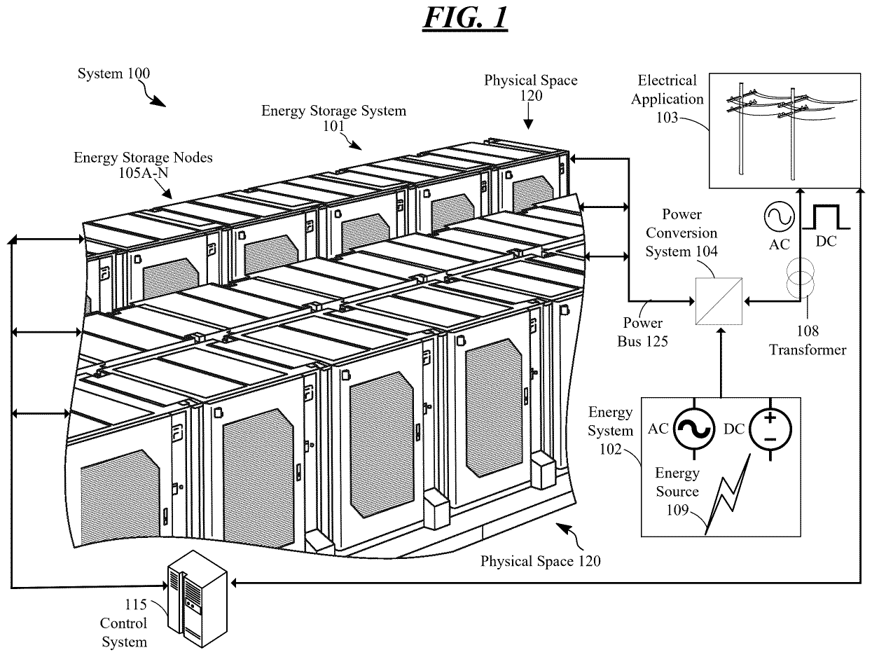

Unless otherwise indicated, any embodiment can be combined with any other embodiment. In particular, FIGS. 1-7 and the associated text are all combinable with each other.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

Reference now is made in detail to the examples illustrated in the accompanying drawings and discussed below.

FIG. 1 depicts a system 100 that includes an energy storage system 101, energy system 102, and an electrical application 103. For example, the energy storage system 101 can be a battery energy storage system (BESS). The energy storage system 101 is coupled to the energy system 102 and the electrical application 103. Energy storage system 101 can include a power conversion system 104, a plurality of energy storage nodes 105A-N, an optional transformer 108, and a control system 115. Components of the energy storage system 101 can be located at a physical space 120 that is outdoors or indoors, for example, inside of a building, a container, or other structure.

As described in further below, energy storage system 101 can be configured to determine limits 117A-N, restrictions 118A-N, or preferences 119A-N based on awareness of: (1) battery conditions 116A-O; and (2) a required power flow 112 or an overall operating intent 113 of the electrical application 103. The limits 117A-N, restrictions 118A-N, or preferences 119A-N are communicated to the control system 115. The control system 115 then determines how to divide dispatch of the required power flow 112 or the overall operating intent 113 across all of the energy storage nodes 105A-N based on the limits 117A-N, restrictions 118A-N, or preferences 119A-N.

Power conversion system 104 is coupled to the plurality of energy storage nodes 105A-N. The power conversion system 104 is coupled to the energy system 102 and the electrical application 103 to provide a required power flow 112 to the electrical application 103 by discharging the plurality of energy storage nodes 105A-N or the required power flow 112 from the energy system 102 for charging the plurality of energy storage nodes 105A-N. The power conversion system 104 can be coupled to an optional transformer 108. The optional transformer 108 can step up or step down the required power flow 112 to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow 112 of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology, including lithium ion, flow batteries, or mechanical storage, such as flywheel energy storage, compressed air energy storage, pumped-storage hydroelectricity, gravitational potential energy, or a hydraulic accumulator.

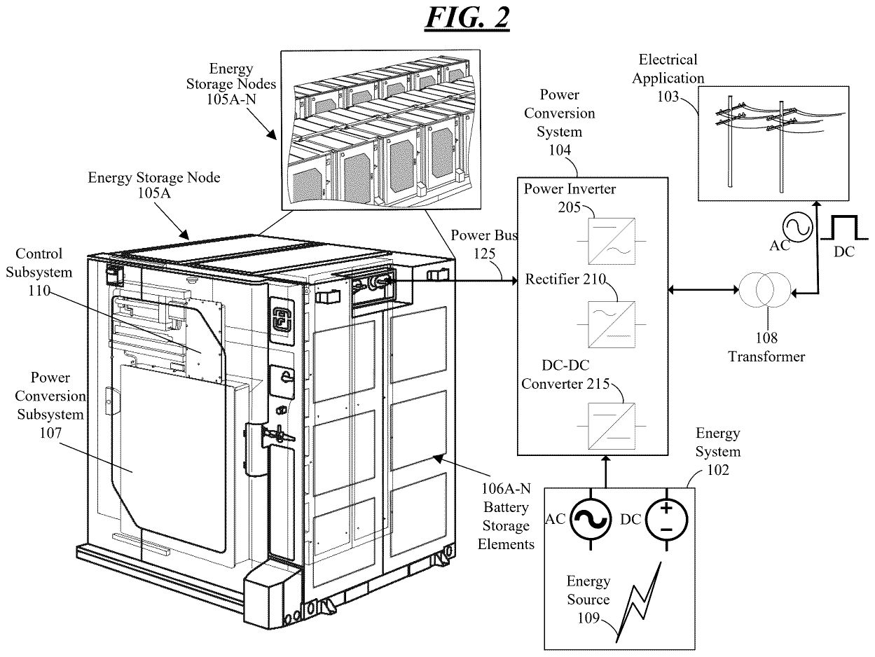

FIG. 2 illustrates a first energy storage node 105A of the plurality of energy storage nodes 105A-N of FIG. 1 coupled to the electrical application 103. Energy storage nodes 105A-N can include a battery storage element 106, a power conversion subsystem 107, and a control subsystem 110 to receive battery data 111A-N from the battery storage element 106, the power conversion subsystem 107, or a combination thereof. Energy storage system 101 can be controlled such that the electrical application 103 is fulfilled while distributing the dispatch of required power flow 112 across the plurality of battery storage elements 106A-N according to awareness of the control system 115 relating to certain battery conditions 116A-O, including a state of charge 116A, a temperature 116B, and other physical phenomena occurring within the battery storage elements 106A-N.

Power conversion system 104 can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow 112 from the energy storage system 101 from DC power into AC power during dispatch to the electrical application 103. For example, the power inverter 205 can be configured to convert power on a power bus 125 for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 is distributed more locally to each of energy storage nodes 105A-N. The control subsystem 110 can be configured for local computation, processing, and control of the battery storage elements 106A-N and the power conversion subsystem 107. The control system 115 can be configured for more centralized computation, processing, and controls of the overall energy storage system 101, energy system 102, electrical application 103, and power conversion system 104. Both the control subsystem 110 and control system 115 can include a single board computer, an application-specific integrated circuit (ASIC), microcontroller, digital signal processor (DSP), field-programmable gate array (FPGA), or a combination thereof.

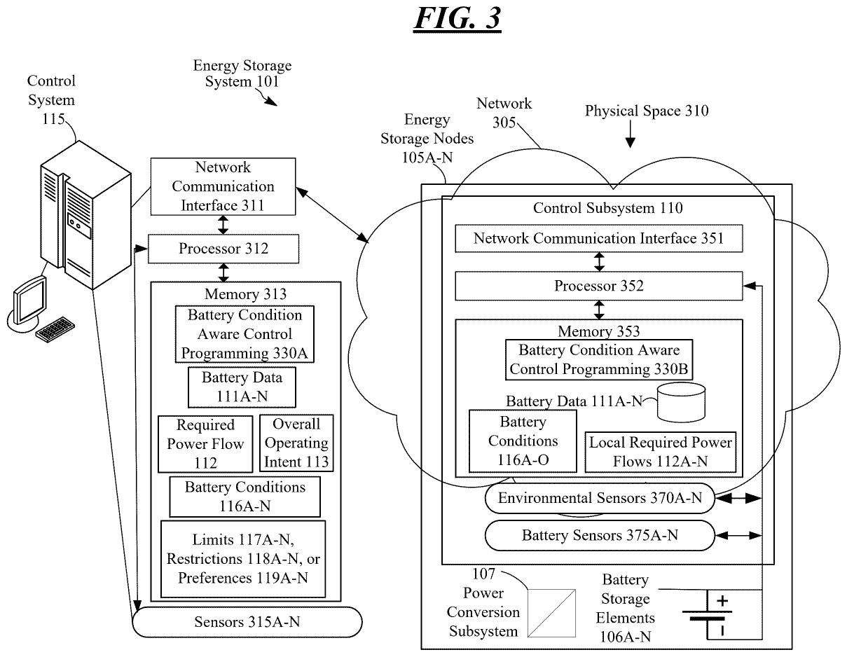

FIG. 3 is a high-level functional block diagram of the energy storage system 101 of FIG. 1 that depicts components of the control system 115 and the energy storage nodes 105A-N to control a required power flow 112 and an overall operating intent 113 based on at least one battery condition 116A-O. As shown, the plurality of energy storage nodes 105A-N include a battery storage element 106A-N, a power conversion subsystem 107, and a control subsystem 110 to receive battery data 111A-N from the battery storage element 106A-N, the power conversion subsystem 107, or a combination thereof.

The control system 115, energy storage nodes 105A-N, electrical application 103, and other components of the system 100 can be in communication over a network 305 or one or more networks 305A-N. The networks 305A-N can be a local area network 305A, wide area network 305B, or a combination thereof. For example, the control system 115 can be coupled via a local area network 305A to the energy storage nodes 105A-N and the electrical application 103. Alternative or additionally, the control system 115 can be coupled via a wide area network 305B to the energy storage nodes 105A-N and electrical application 103. Or the control system 115 can be coupled via a combination of networks 305A-N, such as via a local area network 305A to components of the energy storage system 101, including the energy storage nodes 105A-N, and coupled via a wide area network 305B to the electrical application 103.

Control system 115 includes a network communication interface 311 configured for wired or wireless communication over the network 305. The control system 115 further includes a memory 313, and a processor 312 coupled to the network communication interface 311 and the memory 313. As shown, the memory 313 of the control system 115 is configured to store battery condition aware control programming 330A, battery data 111A-N, a required power flow 112, an overall operating intent 113, battery conditions 116A-O, and local required power flows 112A-N. The control system 115 can also include sensors 315A-N coupled to the processor 312 to detect or monitor various system parameters, such as power, temperature, voltage, current, resistance, and/or impedance. For example, the sensors 315A-N can be coupled to the power bus 125.

Control system 115 is configured to receive or store a required power flow 112 or an overall operating intent 113. The required power flow 112 can include an active power, a reactive power, or a total system power discharge or charge requirement. The required power flow 112 can be a power command for the electrical application 103 based on a customer or independent system operator request received over the network 305 from the electrical application 103, in which case the power command is externally determined.

The overall operating intent 113 can be a power command for the electrical application 103 based on parameters in a customer or independent system operator request received over the network 305 from the electrical application 103. For example, the overall operating intent 113 can be to provide frequency regulation with a deadband and a slope of the response. The control system 115, control subsystem 110, or both can take the parameters of the overall operating intent 113 and attempt to best implement the overall operating intent 113. In this case, the power command to achieve the overall operating intent 113 is internally determined by the control system 115, for example, based on satisfying the customer or independent system operator request for the electrical application 103.

Control system 115 can take the required power flow 112 needed for the electrical application 103, for example, as requested by a customer or software application and determine the optimal way to distribute the required power flow 112 across all of the energy storage nodes 105A-N, given their limits 117A-N, restrictions 118A-N, or preferences 119A-N as described above. This optimization may be conducted in several manners, for example using traditional operational optimization techniques or machine-learning based techniques. The control system 115 can include one or more processors or computing devices that can be configured to perform closed loop management of real and reactive power supplied to the electrical application 103.

Energy storage nodes 105A-N include a control subsystem 110, battery storage elements 106A-N, and a power conversion subsystem 107. Control subsystem 110 of the energy storage nodes 105A-N includes a network communication interface 351 configured for wired or wireless communication over the network 305. The control subsystem 110 further includes a memory 353, and a processor 352 coupled to the network communication interface 351 and the memory 353. As shown, the memory 353 of the control subsystem 110 is configured to store battery condition aware control programming 330B, battery data 111A-N, battery conditions 116A-O, and local required power flows 112A-N.

The control subsystem 110 further includes environmental sensors 370A-N and battery sensors 375A-N coupled to the processor 352. Environmental sensors 370A-N can measure humidity and temperature inside of an enclosure 600 of the energy storage nodes 105A-N. Battery sensors 375A-N can include a voltage sensor 375A, a current sensor 375B, and a temperature sensor 375C to measure readings of battery data 111A-N, such as a voltage 111A, a current 111B, a temperature 111C, or other physical phenomena occurring within the battery storage elements 106A-N.

The control subsystem 110 or the control system 115 is configured to determine at least one battery condition 116A-O about one or more of the energy storage nodes 105A-N from the battery data 111A-N. Battery conditions 116A-O can be algorithmically determined estimates from battery data 111A-N, readings from the sensors 315A-N that monitor various system parameters on the power bus 125, or a combination thereof, for example. State estimating algorithms can take the measured readings of battery data 111A-N, including the voltage 111A, the current 111B, the temperature 111C, or a combination thereof as input parameters and estimate the state of the battery conditions 116A-O based on the battery data 111A-N.

Some state estimating algorithms may receive measured readings from the battery sensors 375A-N of the control subsystem 110 and sensors 315A-N of the control system 115 to derive other parameters, such as real time power. For example, real time power may be derived as a parameter in order to determine the battery conditions 116A-O. To feed the state estimating algorithms for determining battery conditions 116A-O, the control system 115 and control subsystem 110 may implement different restrictions 118B-C, such as a power pulse pattern during battery charging 118B or a power pulse pattern during battery discharging 118C, to generate a range of battery data 111A-N.

Power pulse pattern during battery charging 118B or power pulse pattern during battery discharging 118C are restrictions 118B-C to apply during battery charging or discharging cycles or otherwise use and that can include a higher frequency charge or discharge swing. In an example, the power pulse pattern during battery charging 118B can include to charge to a first voltage for a first period of time, stop charging for a second period of time, then charge to a second voltage for a third period of time, stop charging for a fourth period of time, and then charge to a third voltage for a fifth period of time. The power pulse pattern during battery discharging 118C can include to discharge to a first voltage for a first period of time, stop discharging for a second period of time, then discharge to a second voltage for a third period of time, stop discharging for a fourth period of time, and then discharge to a third voltage for a fifth period of time. The voltages and timing (e.g., periods of time) of the power pulse patterns 118B-C can be adjusted during the charging and discharging cycles to provide a set of battery data 111A-N to feed the state estimating algorithms.

For example, a state of charge 116A is a state estimate derived from the voltage 111A and the current 111B readings. The state of charge 116A can be derived from the control system 115. Alternatively or additionally, a battery management system or the control subsystem 110 can derive the state of charge 116A. Alternatively or additionally, some of the battery conditions 116A-O can be inputted by an operator of the energy storage system 101 into a software application on a separate computing device that is coupled to the control system 115 or the control subsystem 110 over the network 305.

The control system 115 is configured to create one or more limits 117A-N, restrictions 118A-N, or preferences 119A-N on operation of the one or more energy storage nodes 105A-N based on: (1) the at least one battery condition 116A-O; and (2) the required power flow 112 or the overall operating intent 113. The control system 115 is configured to dispatch the required power flow 112 or the overall operating intent 113 across the plurality of energy storage nodes 105A-N based on the one or more limits 117A-N, restrictions 118A-N, or preferences 119A-N on operation.

Limits 117A-N can include hard or otherwise firm limits on battery storage elements 106A-N, energy storage nodes 105A-N, or other components of the energy storage system 101 or system 100, such as do not exceed limits that should not be violated. The limits 117A-N can include a power limit 117A, a state of charge limit 117B, or a temperature limit 117C. The power limit 117A can modify the original design specification rating of energy storage nodes 105A-N, battery storage elements 106A-N, etc. to be different and imposes a hard limit on power that can be charged or discharged. For example, the power limit 117A can be for a battery system element 106A that has an original design specification rating up to 1 megawatt (MW) or 1,000 kilowatts (kW) for maximum charge or discharge. In other words, according to the original design specification, the battery storage element 106A is rated up to 1,000 kW charging and 1,000 kW discharging. The created power limit 117A on the battery system element 106A can be asymmetric, such as up to 800 kW for charging and up to 1,000 kW for discharging or vice versa, which is tighter than the original design specification.

Alternatively, the power limit 117A can be symmetric, such as up to 600 kW for charging and discharging the battery storage element 106A. Similarly, the state of charge limit 117B and the temperature limit 117C can modify the original design specification ratings of the maximum or minimum state of charge and temperature of energy storage nodes 105A-N, battery storage elements 106A-N, etc.

Restrictions 118A-N can be imposed as operational restrictions on battery storage elements 106A-N, energy storage nodes 105A-N, or other components of the energy storage system 101 or the system 100 that should not be violated. The restrictions can include a do not run instruction 118A, a power pulse pattern during battery charging 118B, or a power pulse pattern during battery discharging 118C. In an example, the do not run instruction 118A can include to remove a battery storage element 106A or an energy storage node 105A as an active element of the energy storage system 101. The do not run instruction 118A can take the battery storage element 106A offline, such as due to performance or safety concerns. The do not run instruction 118A can be a true restriction, such as do not charge the energy storage node 105A above 80 percent of the rated power capacity. The do not run instruction 118A can be to not run the battery storage element 106A above 80 percent of the state of charge 116A or do not run the battery storage element 106A if the temperature 116B is below 20 degrees Celsius.

The power pulse pattern during battery charging 118B and the power pulse pattern during battery discharging 118C can be created as restrictions 118B-C to heal a defect in the battery storage elements 106A-N. For example, the power pulse patterns 118B-C can be created as restrictions 118B-C when the battery conditions 116I-K indicate a certain level of lithium loss, such as based on a remaining lithium inventory/lithium inventory loss 116I, a lithium plating on an anode or a cathode active material 116J, or a lithium dendrite growth on an anode active material 116K, or a combination thereof.

Preferences 119A-N can be a softer limit on battery storage elements 106A-N, energy storage nodes 105A-N, or other components of the energy storage system 101 or the system 100 that should not be violated, if possible. A first preference 119A can be a soft limit on an operating parameter, such as do not charge a battery storage element 106A or an energy storage node 105A above 80 percent of power capacity. The control system 115 or control subsystem 110 can determine a cost benefit of not charging the battery storage element 106A or the energy storage node 105A above 80 percent. The control system 115 or control subsystem 110 may only violate the preference 119A and charge the battery storage element 106A or the energy storage node 105A above 80 percent of power capacity if necessary to satisfy the required power flow 112 or the overall operating intent 113. The control system 115 or the control subsystem 110 can determine how to dispatch the required power flow 112 or the overall operating intent 113 as a cost function and dispatch using the lowest cost basis by assigning a cost function to each energy storage node 105A-N and reparametrizing the cost function. A second preference 119B can be an apparent power. A third preference 119C can be a soft do not run instruction, such as to remove a battery storage element 106A or an energy storage node 105A as an active element of the energy storage system 101, if possible.

Dispatching the required power flow 112 across the plurality of energy storage nodes 105A-N based on the one or more limits 117A-N, restrictions 118A-N, or preferences 119A-N can include dividing the required power flow 112 across all of the energy storage nodes 105A-N based on the one or more limits 117A-N, restrictions 118A-N, or preferences 119A-N on operation. For example, dividing the required power flow 112 across the plurality of energy storage nodes 105A-N based on the one or more limits 117A-N, restrictions 118A-N, or preferences 119A-N includes dividing a total required power flow 112 across all of the energy storage nodes 105A-N into a plurality of local required power flows 112A-N based on the one or more limits 117A-N, restrictions 118A-N, or preferences 119A-N on operation. The control system 115 can be configured to distribute a respective one of the local required power flows 112A-N to each of the energy storage nodes 105A-N based on the one or more limits 117A-N, restrictions 118A-N, or preferences 119A-N on operation.

Following is an example of dispatching the required power flow 112. An energy storage system 101 includes four energy storage nodes 105A-D each with a 1 kW power capacity rating as the original design specification. This means there is a total capacity in the energy storage system 101 to discharge 4 kW power. But the required power flow 112 is to provide 3.5 kW power. The default setting would be for the control system 115 to dispatch 875 kW to each of the four energy storage nodes 105A-D by dividing the 3.5 kW required power flow 112 up equally among all of the energy storage nodes 105A-D. But the control system 115 creates a power limit 117A of 800 kW on the first energy storage node 105A based on the battery conditions 116A-O at the first energy storage node 105A. Hence, the control system 115 allocates a local required power flow 112A of 800 kW to the first energy storage node 105A and allocates local required power flows 112B-D of 900 kW each to the other energy storage nodes 105B-D.

Each of the energy storage nodes 105A-N can include the power conversion subsystem 107 for controlling the respective one of the local required power flows 112A-N. The battery data 111A-N can include a voltage 111A, a current 111B, a temperature 111C, or other physical phenomena occurring within the battery storage element 106, or a combination thereof.

The control system 115 can manage power commands to the control subsystem 110 to charge or discharge the plurality of energy storage nodes 105A-N based on the local required power flows 112A-N. For example, the control system 115 can send the power commands based on the total required power flow 112 to the plurality of energy storage nodes 105A-N. Alternatively or additionally, the control subsystem 110 can issue the power commands directly at the plurality of energy storage nodes 105A-N based on the local required power flows 112A-N.

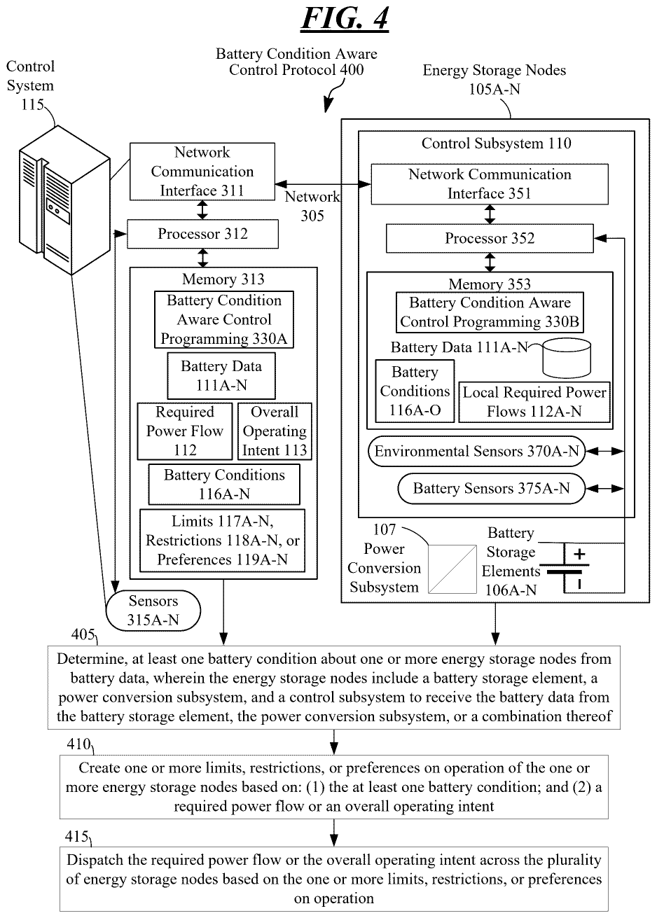

FIG. 4 is a battery condition aware control protocol 400 for the energy storage system 101 that is implemented by the control system 115 and the plurality of energy storage nodes 105A-N. According to the battery condition aware protocol 400, battery data 111A-N can be utilized to generate insights on battery conditions 116A-O within an energy storage node 105A. Based on the battery conditions 116A-O known from these insights, the control system 115 can create limits 117A-N, restrictions 118A-N, or preferences 119A-N on the operation of the energy storage node 105A.

In the example of FIG. 4, the battery condition aware control protocol 400 is implemented in the battery condition aware control programming 330A of the control system 115 and the battery condition aware control programming 330B of the control subsystem 110. Execution of battery condition aware control programming 330A stored in a memory 313 by a processor 312 of the control system 115 causes the control system 115 to implement blocks 410 and 415 and optionally implement block 405 described below. Execution of battery condition aware control programming 330B stored in a memory 353 by a processor 352 of the control subsystem 110 causes the energy storage nodes 105A-N to optionally implement block 405 described below. More generally, the execution of the battery condition aware control programming 330A-B by one or more processors 312, 352 can configure one or more computing devices 115, 110 to implement blocks 405, 410, and 415 below.

Beginning in block 405, the battery condition aware control protocol 400 includes to determine, at least one battery condition 116A-O about one or more energy storage nodes 105A-N from battery data 111A-N. The energy storage nodes 105A-N can include a battery storage element 106, a power conversion subsystem 107, and a control subsystem 110 to receive the battery data 111A-N from the battery storage element 106, the power conversion subsystem 107, or a combination thereof.

Moving now to block 410, the battery condition aware control protocol 400 further includes to create one or more limits 117A-N, restrictions 118A-N, or preferences 119A-N on operation of the one or more energy storage nodes 105A-N based on: (1) the at least one battery condition 116A-O; and (2) a required power flow 112 or an overall operating intent 113 Finishing now, in block 415, the battery condition aware control protocol 400 further includes to dispatch the required power flow 112 or the overall operating intent 113 across the plurality of energy storage nodes 105A-N based on the one or more limits 117A-N, restrictions 118A-N, or preferences 119A-N on operation. Dispatching the required power flow 112 or the overall operating intent 113 across the plurality of energy storage nodes 105A-N based on the one or more limits 117A-N, restrictions 118A-N, or preferences 119A-N can include dividing the required power flow 112 or the overall operating intent 113 across all of the energy storage nodes 105A-N based on the one or more limits 117A-N, restrictions 118A-N, or preferences 119A-N on operation.

For example, dividing the required power flow 112 across the plurality of energy storage nodes 105A-N based on the one or more limits 117A-N, restrictions 118A-N, or preferences 119A-N includes dividing a total required power flow 112 across all of the energy storage nodes 105A-N into a plurality of local required power flows 112A-N based on the one or more limits 117A-N, restrictions 118A-N, or preferences 119A-N on operation.

The control system 115 can be configured to distribute a respective one of the local required power flows 112A-N to each of the energy storage nodes 105A-N based on the one or more limits 117A-N, restrictions 118A-N, or preferences 119A-N on operation. Each of the energy storage nodes 105A-N can include the power conversion subsystem 107 for controlling the respective one of the local required power flows 112A-N.

In FIG. 4, the local control subsystem 110 can implement a subset or all of the blocks 405, 410, and 415 of the battery condition aware control protocol 400 without the central control system 115. For example, the required power flow 112 or the overall operating intent 113 can be stored or received by one, a subset, or all of the control subsystem(s) 110 of the energy storage nodes 105A-N from the electrical application 103 over the network 305. The control subsystem 110 of the energy storage nodes 105A-N that receives the required power flow 112 or the overall operating intent 113 can then implement blocks 405, 410, and 415.

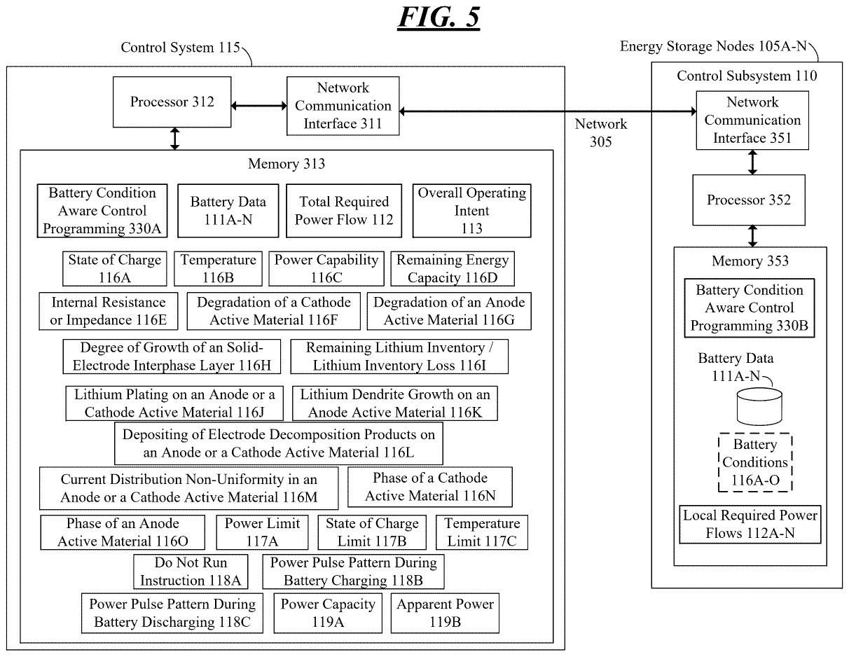

FIG. 5 is a block diagram of the control system 115 depicting various types of battery conditions 116A-O and the plurality of energy storage nodes 105A-N to implement the battery condition aware control protocol 400 of FIG. 4. As shown, the at least one battery condition can include: a state of charge 116A, a temperature 116B, a power capability 116C, remaining energy capacity 116D, an internal resistance or impedance 116E, a degradation of a cathode active material 116F, a degradation of an anode active material 116G, a degree of growth of a solid-electrode interphase (SEI) layer 116H, remaining lithium inventory/lithium inventory loss 116I, lithium plating on an anode or a cathode active material 116J, a lithium dendrite growth on an anode active material 116K, depositing of electrode decomposition products on an anode or a cathode active material 116L, a current distribution non-uniformity in an anode or a cathode active material 116M, a phase of a cathode active material 116N, a phase of an anode active material 1160, or a combination thereof.

The one or more limits 117A-N, restrictions 118A-N, or preferences 119A-N can include a power limit 117A, a state of charge limit 117B, a temperature limit 117C, a do not run instruction 118A, a power pulse pattern during battery charging 118B, a power pulse pattern during battery discharging 118C, a power capacity 119A, or an apparent power 119B. The apparent power 119B can be measured in volt-amperes (VA). Those skilled in the art may identify other limits 117A-N, restrictions 118A-N, or preferences 119A-N that would fall within the scope. The limits 117A-N and restrictions 118A-N may be in the form of hard limits, meaning the control system 115 must abide by the limits 117A-N or restrictions 118A-N. Alternatively, the preferences 119A-N may be in the form of a soft limit, such as a desired behavior, meaning the control system 115 should attempt to obey such preferences 119A-N if practical.

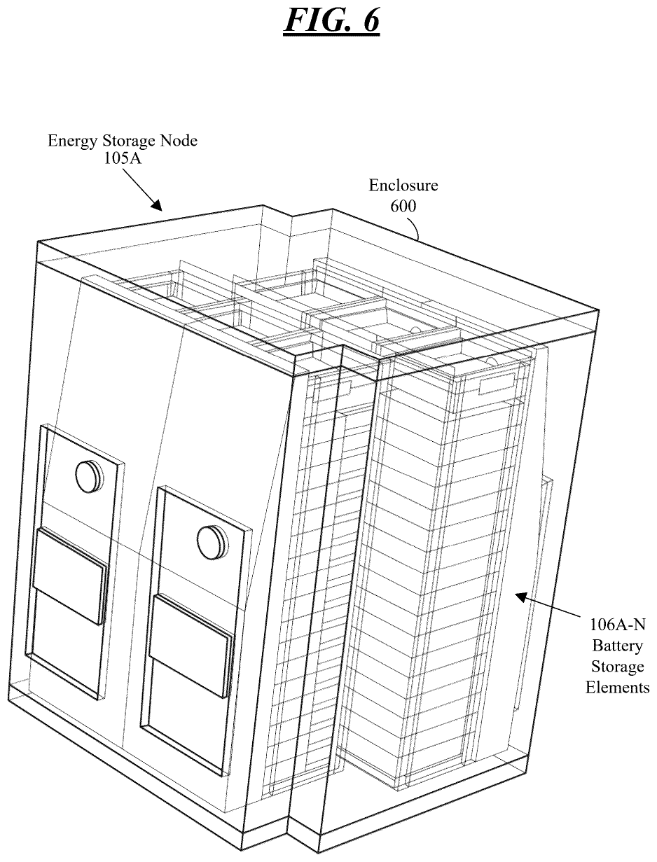

FIG. 6 is a cutaway view of the first energy storage node 105A of the plurality of energy storage nodes 105A-N and shows details of a plurality of battery storage elements 106A-N. As shown, the energy storage node 105A includes an enclosure 600, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 6, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

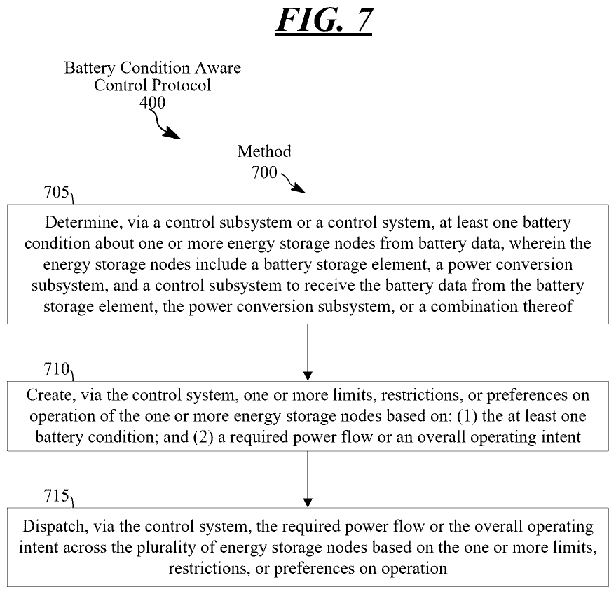

FIG. 7 is a flowchart of a method 700 that can be implemented to control a required power flow 112 and an overall operating intent 113 based on at least one battery condition 116A-O. In the example of FIG. 7, the method 700 implements the battery condition aware control protocol 400 of FIG. 4. Beginning in step 705, the method 700 includes determining, via a control subsystem 110 or a control system 115, at least one battery condition 116A-O about one or more energy storage nodes 105A-N from battery data 116A-O. The energy storage nodes 105A-N can include a battery storage element 106, a power conversion subsystem 107, and a control subsystem 110 to receive the battery data 111A-N from the battery storage element 106, the power conversion subsystem 107, or a combination thereof.

Continuing to step 710, the method 700 further includes creating, via the control system 115, one or more limits 117A-N, restrictions 118A-N, or preferences 119A-N on operation of the one or more energy storage nodes 105A-N based on: (1) the at least one battery condition 116A-O; and (2) a required power flow 112 or an overall operating intent 113.

Finishing now, in step 715, the method 700 further includes dispatching, via the control system 115, the required power flow 112 or the overall operating intent 113 across the plurality of energy storage nodes 105A-N based on the one or more limits 117A-N, restrictions 118A-N, or preferences 119A-N on operation.

In FIG. 7, the local control subsystem 110 can implement a subset or all of the steps 705, 710, and 715 of the method 700 without the central control system 115. For example, the required power flow 112 or the overall operating intent 113 can be stored or received by one, a subset, or all of the control subsystem(s) 110 of the energy storage nodes 105A-N from the electrical application 103 over the network 305. The control subsystem 110 of the energy storage nodes 105A-N that receives the required power flow 112 or the overall operating intent 113 can then implement steps 705, 710, and 715.

In the examples above, the energy system 102, energy application 103, power conversion system 104, energy storage nodes 105A-N, control subsystem 110, control system 115, etc. each include a network communication interface 311, 351 for wired or wireless communication over one or more networks 305A-N. The networks 305A-N interconnect the links to/from the network communication interfaces 311, 351 of the devices, so as to provide data communications amongst the energy application 103, energy storage nodes 105A-N, control subsystem 110, control system 115, etc. Networks 305A-N may support data communication by equipment at the premises via wired (e.g., cable or fiber) media or via wireless (e.g., Wi-Fi, Bluetooth™, ZigBee, LiFi, IrDA, etc.) or combinations of wired and wireless technology.

Any of the functionality of the battery condition aware control protocol 400, including battery condition aware control programming 330A-B, described herein for the energy system 102, electrical application 103, power conversion system 104, energy storage nodes 105A-N, control subsystem 110, control system 115, etc. can be embodied in one more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the energy system 102, energy application 103, power conversion system 104, energy storage nodes 105A-N, control subsystem 110, control system 115, etc. can each include a processor. As used herein, a processor 312, 352 is a hardware circuit having elements structured and arranged to perform one or more processing functions, typically various data processing functions. Although discrete logic components could be used, the examples utilize components forming a programmable central processing unit (CPU). A processor 312, 352 for example includes or is part of one or more integrated circuit (IC) chips incorporating the electronic elements to perform the functions of the CPU. The processors 312, 352 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 312, 352 can include one microprocessor or a multi-processor architecture. A digital signal processor (DSP) or field-programmable gate array (FPGA) could be suitable replacements for the processors 312, 352, but may consume more power with added complexity.

The applicable processor 312, 352 executes programming or instructions to configure the energy system 102, energy application 103, power conversion system 104, energy storage nodes 105A-N, control subsystem 110, control system 115, etc. to perform various operations. For example, such operations may include various general operations (e.g., a clock function, recording and logging operational status and/or failure information) as well as various system-specific operations (e.g., daylighting and/or energy management) functions. Although a processor 312, 352 may be configured by use of hardwired logic, typical processors are general processing circuits configured by execution of programming, e.g., instructions and any associated setting data from the memories 313, 353 shown or from other included storage media and/or received from remote storage media.

In the examples above, the energy system 102, energy application 103, power conversion system 104, energy storage nodes 105A-N, control subsystem 110, control system 115, etc. each include a memory. The memory 313, 353 may include a flash memory (non-volatile or persistent storage), a read-only memory (ROM), and a random access memory (RAM) (volatile storage). The RAM serves as short term storage for instructions and data being handled by the processors 312, 352 e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the battery condition aware control protocol 400 and the battery condition aware control programming 330A-B. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the battery condition aware control protocol 400 and the battery condition aware control programming 330A-B, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 312, 352 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the battery condition aware control protocol 400 and the battery condition aware control programming 330A-B, the programming or software can be stored in a computer program product or non-transitory computer readable medium and loaded into the computing device using a removable storage drive or communications interface. In an exemplary embodiment, any computing device, such as control system 115 and control subsystem 110, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. An energy storage system, comprising:
a plurality of energy storage nodes, wherein the plurality of energy storage nodes include a battery storage element, a power conversion subsystem, and a control subsystem to receive battery data from the battery storage element, the power conversion subsystem, or a combination thereof;
a control system configured to receive or store a required power flow or an overall operating intent;
wherein:
the control subsystem or the control system is configured to determine at least one battery condition about one or more of the energy storage nodes from the battery data;
the control system is configured to create one or more limits, restrictions, or preferences on operation of the one or more energy storage nodes based on: (1) the at least one battery condition; and (2) the required power flow or the overall operating intent; and
the control system is configured to dispatch the required power flow or the overall operating intent across the plurality of energy storage nodes based on the one or more limits, restrictions, or preferences on operation.

2. The energy storage system of claim 1, wherein:
the one or more limits, restrictions, or preferences on operation are based on the required power flow; and
dispatching the required power flow across the plurality of energy storage nodes based on the one or more limits, restrictions, or preferences includes dividing the required power flow across all of the energy storage nodes based on the one or more limits, restrictions, or preferences on operation.

3. The energy storage system of claim 2, wherein:
dividing the required power flow across the plurality of energy storage nodes based on the one or more limits, restrictions, or preferences includes dividing a total required power flow across all of the energy storage nodes into a plurality of local required power flows based on the one or more limits, restrictions, or preferences on operation; and
the control system is configured to distribute a respective one of the local required power flows to each of the energy storage nodes based on the one or more limits, restrictions, or preferences on operation.

4. The energy storage system of claim 3, wherein each of the energy storage nodes includes the power conversion subsystem for controlling the respective one of the local required power flows.

5. The energy storage system of claim 2, wherein the battery data includes a voltage, a current, a temperature, or a combination thereof.

6. The energy storage system of claim 2, wherein the at least one battery condition includes: a state of charge, a temperature, a power capability, remaining energy capacity, an internal resistance or impedance, a degradation of a cathode active material, a degradation of an anode active material, a degree of growth of a solid-electrode interphase (SEI) layer, remaining lithium inventory/lithium inventory loss, lithium plating on an anode or a cathode active material, a lithium dendrite growth on an anode active material, depositing of electrode decomposition products on an anode or a cathode active material, a current distribution non-uniformity in an anode or a cathode active material, a phase of a cathode active material, a phase of an anode active material, or a combination thereof.

7. The energy storage system of claim 2, wherein the one or more limits, restrictions, or preferences include a power limit, a state of charge limit, a temperature limit, a do not run instruction, a power pulse pattern during battery charging, a power pulse pattern during battery discharging, a power capacity, or an apparent power.

8. The energy storage system of claim 2, wherein the required power flow includes an active power, a reactive power, or a total system power discharge or charge requirement.

9. The energy storage system of claim 1, further comprising:
a power conversion system coupled to the plurality of energy storage nodes,
wherein the power conversion system is coupled to an energy system and an electrical application to provide the required power flow to the electrical application by discharging the plurality of energy storage nodes or the required power flow from the energy system for charging the plurality of energy storage nodes.

10. A system, comprising:
the energy storage system of claim 1;
an energy system; and
an electrical application.

11. A non-transitory computer-readable medium, comprising battery condition aware control programming, wherein execution of the battery condition aware control programming by one or more processors configures one or more computing devices to:
determine, at least one battery condition about one or more energy storage nodes from battery data, wherein the energy storage nodes include a battery storage element, a power conversion subsystem, and a control subsystem to receive the battery data from the battery storage element, the power conversion subsystem, or a combination thereof;
create one or more limits, restrictions, or preferences on operation of the one or more energy storage nodes based on: (1) the at least one battery condition; and (2) a required power flow or an overall operating intent; and
dispatch the required power flow or the overall operating intent across the plurality of energy storage nodes based on the one or more limits, restrictions, or preferences on operation.

12. The non-transitory computer-readable medium of claim 11, wherein:
the one or more limits, restrictions, or preferences on operation are based on the required power flow; and
dispatching the required power flow across the plurality of energy storage nodes based on the one or more limits, restrictions, or preferences includes dividing the required power flow across all of the energy storage nodes based on the one or more limits, restrictions, or preferences on operation.

13. The non-transitory computer-readable medium of claim 12, wherein:
dividing the required power flow across all of the energy storage nodes based on the one or more limits, restrictions, or preferences includes dividing a total required power flow across all of the energy storage nodes into a plurality of local required power flows based on the one or more limits, restrictions, or preferences on operation; and
execution of the battery condition aware control programming by the one or more processors configures the one or more computing devices to distribute a respective one of the local required power flows to each of the energy storage nodes based on the one or more limits, restrictions, or preferences on operation.

14. The non-transitory computer-readable medium of claim 12, wherein the at least one battery condition includes: a state of charge, a temperature, a power capability, remaining energy capacity, an internal resistance or impedance, a degradation of a cathode active material, a degradation of an anode active material, a degree of growth of a solid-electrode interphase (SEI) layer, remaining lithium inventory/lithium inventory loss, lithium plating on an anode or a cathode active material, a lithium dendrite growth on an anode active material, depositing of electrode decomposition products on an anode or a cathode active material, a current distribution non-uniformity in an anode or a cathode active material, a phase of a cathode active material, a phase of an anode active material, or a combination thereof.

15. The non-transitory computer-readable medium of claim 12, wherein the one or more limits, restrictions, or preferences include a power limit, a state of charge limit, a temperature limit, a do not run instruction, a power pulse pattern during battery charging, a power pulse pattern during battery discharging, a power capacity, or an apparent power.

16. A method, comprising:
determining, via a control subsystem or a control system, at least one battery condition about one or more energy storage nodes from battery data, wherein the energy storage nodes include a battery storage element, a power conversion subsystem, and a control subsystem to receive the battery data from the battery storage element, the power conversion subsystem, or a combination thereof;
creating, via the control system, one or more limits, restrictions, or preferences on operation of the one or more energy storage nodes based on: (1) the at least one battery condition; and (2) a required power flow or an overall operating intent; and
dispatching, via the control system, the required power flow or the overall operating intent across the plurality of energy storage nodes based on the one or more limits, restrictions, or preferences on operation.

17. The method of claim 16, wherein:
the one or more limits, restrictions, or preferences on operation are based on the required power flow; and
dispatching, via the control system, the required power flow across the plurality of energy storage nodes based on the one or more limits, restrictions, or preferences includes dividing the required power flow across all of the energy storage nodes based on the one or more limits, restrictions, or preferences on operation.

18. The method of claim 17, wherein:
dividing the required power flow across all of the energy storage nodes based on the one or more limits, restrictions, or preferences includes dividing a total required power flow across all of the energy storage nodes into a plurality of local required power flows based on the one or more limits, restrictions, or preferences on operation; and
further comprising distributing, via the control system, a respective one of the local required power flows to each of the energy storage nodes based on the one or more limits, restrictions, or preferences on operation.

19. The method of claim 17, wherein:
wherein the at least one battery condition includes: a state of charge, a temperature, a power capability, remaining energy capacity, an internal resistance or impedance, a degradation of a cathode active material, a degradation of an anode active material, a degree of growth of a solid-electrode interphase (SEI) layer, remaining lithium inventory/lithium inventory loss, lithium plating on an anode or a cathode active material, a lithium dendrite growth on an anode active material, depositing of electrode decomposition products on an anode or a cathode active material, a current distribution non-uniformity in an anode or a cathode active material, a phase of a cathode active material, a phase of an anode active material, or a combination thereof.

20. The method of claim 17, wherein the one or more limits, restrictions, or preferences include a power limit, a state of charge limit, a temperature limit, a do not run instruction, a power pulse pattern during battery charging, a power pulse pattern during battery discharging, a power capacity, or an apparent power.
